(19) United States
(12) Patent Application Publication
(10) Pub. No.: US 2004/0160544 A1
(43) Pub. Date: Aug. 19, 2004

(54) Multilayer storage capacitors for a liquid crystal display panel and the method for fabricating the same

(76) Inventor: Yuan-Tung Dai, Chung-Li City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/366,553

(22) Filed: Feb. 14, 2003

(51) Int. Cl. G02F 1/136

(52) U.S. Cl. 349/43

(57) ABSTRACT

A method for fabricating multilayer storage capacitors of an LCD panel is disclosed. For a two-layer storage capacitor, the structure includes a thin film transistor region over a first substrate, a pixel electrode disposed on the periphery of the thin film transistor region, and a plurality of oxide layers. The oxide layers have data lines and gate lines, wherein the crossover of each gate line and data line corresponds to the position of a pixel electrode. An oxide layer can be added between the pixel electrode and the first substrate for creating a three-layer storage capacitor, wherein the shielding layer or semiconductor active layer is connected to the gate line. Having a small interlayer gap between the transparent electrode layer and the first metal layer and no cross talk, the capacitance of the storage capacitor can be considerably increased.

### BACKGROUND OF THE INVENTION

1. Field of the Invention

The present invention relates to the fabrication of multilayer storage capacitors for a liquid crystal display (LCD) panel and the methods for fabricating the same, in particular to the fabrication of storage capacitors for an LCD panel possessing high capacitance but being small in size.

2. Description of Related Arts

A method of providing a storage capacitor in parallel with a pixel electrode to produce high quality display images has been known. Active matrix driver circuits are used to control the pixel array on an LCD panel, composing of numerous pixel regions, data and gate lines crossing over each other to define the pixel regions, and numerous thin film transistors positioned near the crossover points of the data and gate lines. The pixel output is controlled by different voltages applied to the corresponding liquid crystal.

The structure of the LCD panel includes a plurality of transistors, storage capacitors, and transparent electrodes positioned at the crossover points of data lines and gate lines in matrix form. The driver circuit for a single pixel is composed of a transistor, a transparent electrode layer and a storage capacitor. Through the data line and gate line, a write signal is selectively output to a location on the transparent electrode layer to control the output of that pixel electrode.

As shown in FIG. 5, the LCD panel manufactured with the above-mentioned structure includes a thin film transistor region (501) and a storage capacitor region (502) built on top of a transparent substrate (50).

The structure of the thin film transistor includes a buffer layer (51), a semiconductor active layer (52), a second oxide layer (53), a gate electrode (56), a first metal layer (58), a third oxide layer (54), a second metal layer (59), a passivation layer (55) and a transparent electrode layer (57) respectively formed over the substrate (50).

One part of the semiconductor active layer (52) corresponds to the position on the thin film transistor region (501), and the other part of the semiconductor active layer (52a) corresponds to the storage capacitor region (502) on the substrate (50), wherein a source electrode (522) and a drain electrode (521) are defined over the semiconductor active layer (52). A gate insulating layer (53a) is formed on the second oxide layer (53) corresponding to the position on the semiconductor active layer (52), wherein the gate electrode (56) is formed on the gate insulating layer (53a), thus forming a thin film transistor region, and the drain electrode (521) and the source electrode (522) are respectively connected to the second metal layer (59) as connecting terminals.

The part of semiconductor active layer (52a) corresponding to the storage capacitor region (502) also has corresponding positions on the first metal layer (58) and the second metal layer (59). With the first metal layer (58) disposed in between the semiconductor active layer (52a)-and the second metal layer (59), a two-layer storage capacitor can be formed by the semiconductor active layer (52a) and the first metal layer (58); or else, it can also be formed by the second metal layer (59) and the first metal layer (58). The second metal layer (59) can be connected to the semiconductor active layer (52) to create a three-layer storage capacitor. The transparent electrode layer (57) is formed on the top layer of the substrate (50) allowing for wire connection between the second metal layer (59) of the storage capacitor and the second metal layer (59) of the thin film transistor, such that the storage capacitor and the thin film transistor are electrically connected. The transparent electrode layer (57) is formed close to the liquid crystal (not shown in the diagram).

Since cross talks exist in between the first and second metal layers (58, 59) in signal communication, it is necessary to provide a wider gap between the first and second metal layers (58, 59) to prevent such interference, but the wider gap will result in decreasing the capacitance of the storage capacitor. It is therefore difficult to increase the capacitance of the storage capacitors of the LCD panel with the above structure of the first and second metal layers.

### SUMMARY OF THE INVENTION

The main object of the present invention is to provide an inversely oriented transistor that is able to increase of the capacitance on the storage capacitors of an LCD panel, such that the non-transparent part will take up less space in the transistor, and cross talks can be prevented in between the first and second metal layers.

In accordance with the present invention, a storage capacitor region, a thin film transistor region, a transparent electrode layer, and a plurality of gate lines and data lines are formed on a substrate. The thin film capacitor is inversely installed on the substrate having a semiconductor active layer, a gate insulating layer and a gate electrode. The transparent electrode layer is formed on the periphery of the thin film transistor region overlaying a plurality of oxide layers. The gate line is formed by a first metal layer embedded in the oxide layers in between the gate electrode and the substrate. The data line also embedded in the oxide layers is formed by the second metal layer used to connect the transparent electrode layer and the thin film transistor region.

In the above mentioned structure, a two-layer storage capacitor is formed by the transparent electrode layer and the first metal layer, and an insulating layer is formed in between the first metal layer and the transparent electrode layer to act as the dielectric layer for the storage capacitor. The other part of the transparent electrode layer is also connected to the corresponding position on the semiconductor active layer through the second metal to connect the storage capacitor and the thin film transistor; that means the transparent electrode layer acts as an electrode plate for the storage capacitor. Since there are no cross talks between the transparent electrode layer and the first metal layer, the thickness of the oxide layer can be decreased to make the first metal layer and the transparent electrode closer together so as to increase the capacitance of the storage capacitor. According to the basic principles, the capacitance of the storage capacitor is inversely proportional to the distance between the electrode plates. The capacitance of the storage capacitor therefore can be considerably increased under the present invention.

The second object of the invention is to provide an LCD panel that can prevent electric leakage induced by photo current effect with the formation of a transparent oxide layer in between the substrate, the semiconductor active layer, and the transparent electrode, wherein the transparent oxide layer has a shielding layer on the inner surface corresponding to the positions on the semiconductor active layer, the first metal layer, and the second metal layer.

The third object of the invention is to provide a three-layer storage capacitor for an LCD panel, wherein a transparent electrode layer, an oxide layer, and a shielding layer or semiconductor film are respectively formed over a substrate. The first metal layer is connected to a shielding layer or semiconductor active layer, so that a three layer storage capacitor is formed by the transparent electrode layer, the first metal layer, and the shielding layer or the semiconductor active layer.

The storage capacitor possessing high capacitance can be formed on a silicon substrate with simple metallizing and lithography processes, thus the process costs can be reduced.

The features and structure of the present invention will be more clearly understood when taken in conjunction with the accompanying drawings.

### BRIEF DESCRIPTION OF THE DRAWINGS

FIG. 1 is a cross-sectional view of the thin film transistor region for an LCD panel after completing the back-end fabrication in accordance with the first embodiment of the invention;

FIG. 2 is a cross-sectional view of the fabrication of thin film transistor for an LCD panel;

FIG. 3 is a cross-sectional view of the thin film transistor for an LCD panel after the back-end fabrication in accordance with the second embodiment of the invention;

FIG. 4 is a cross-sectional view of the thin film transistor for an LCD panel after the back-end fabrication in accordance with the third embodiment of the invention; and

FIG. 5 is the driver circuit for a single pixel electrode in a conventional liquid crystal display.

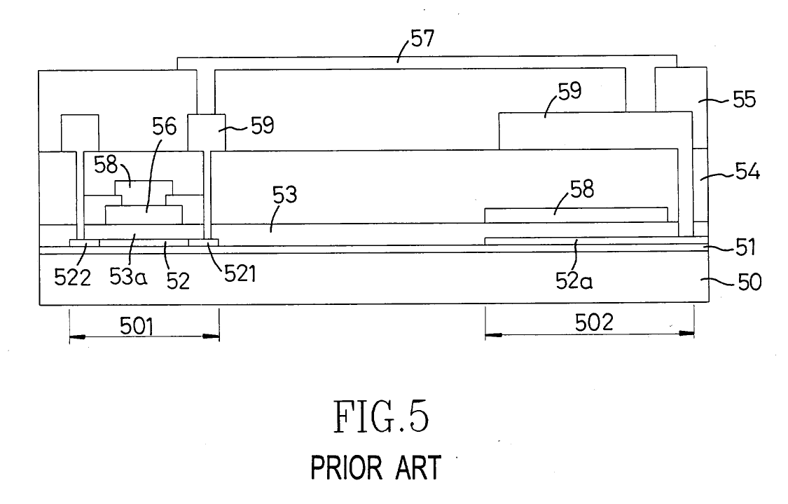

### DETAILED DESCRIPTION OF THE PREFERRED EMBODIMENT

The present invention provides a multilayer storage capacitor for an LCD panel having the benefits of high capacitance and with using simple lithography and metallizing processes.

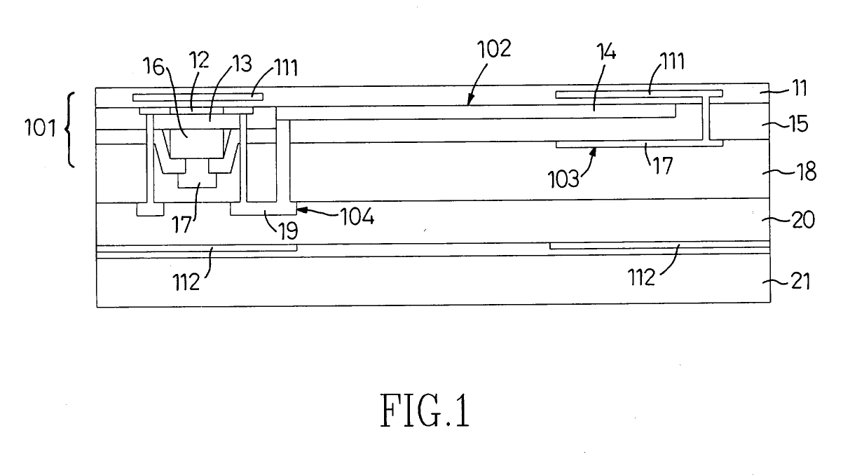

In FIG. 1, the driver circuit for a single LCD pixel, is composed of a substrate (21), a thin film transistor (101), a pixel electrode (102), a gate line (103) and a data line (104).

The substrate (21) has fully flat inner and outer surfaces, wherein a thin film transistor (101), a pixel electrode (102), and a gate line (103) and a data line (104) are respectively created thereon, and the substrate (21) is made from silicon, glass or any other polymer materials;

The thin film transistor region (101), inversely disposed on the substrate (21), is formed by a semiconductor active layer (12), a gate insulating layer (13), and a gate electrode (16).

The pixel electrode (102) is created from the transparent electrode layer (14) on the periphery of the thin film transistor region (101). The pixel electrode (102) can be created on the same layer as the gate insulating layer (13) or gate electrode (16), overlying transparent interlayer oxide between the transparent electrode layer (14) and the substrate (21). In the present embodiment, the interlayer oxide is formed by a first insulating layer (15) and a second oxide layer (18).

The gate line (103) is formed by the first metal layer (17), disposed under the gate electrode (16) of the thin film transistor region (101) and in between the first and second oxide layers (15, 18).

The data line (104) is formed by the second metal layer (18) for connecting the transparent electrode layer (14) and the thin film transistor region 101).

An insulating layer (15) is formed between one part of the transparent electrode layer (14) and the first metal layer (17) for creating a two-layer storage capacitor.

A buffer layer (11) is formed on the top layer of the storage capacitor, wherein a first shielding layer (111) is formed in the buffer layer (11) corresponding to the positions on the thin film transistor region ( 101) and the first metal layer (17), and the first shielding layer (111) is connected to the first metal layer (17). A three-layer storage capacitor is formed by the transparent electrode layer (14), the first metal layer (17) and the first shielding layer (111). The transparent electrode layer (14) acts as an electrode plate for the storage capacitor, and interconnect the thin film transistor region (101) and the storage capacitor without adding one more lithography or metallizing process.

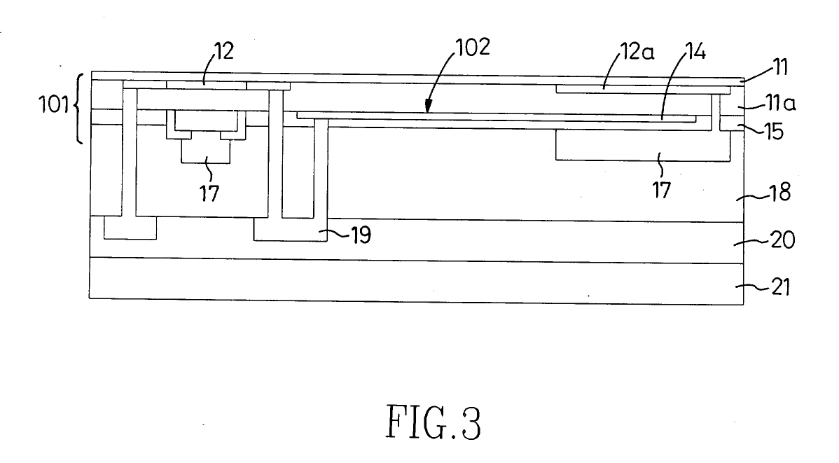

In FIG. 3 a thin film display panel is manufactured in accordance with the second embodiment of the invention, which is basically similar to that in the first embodiment, except that a semiconductor active layer (12) is used in the formation of the thin film transistor region (10), and that a part of the semiconductor active layer (12a) is reserved to correspond to the position on the storage capacitor. Also, a fourth oxide layer (11a) is formed underneath the semiconductor active layer (12, 12a). One part of the transparent electrode layer (14) through the fourth oxide layer (11a) corresponds to the semiconductor active layer (12a) to form a two-layer storage capacitor. A three layer storage capacitor can be formed by connecting the first metal layer (17) to the semiconductor active layer (12a), together with the transparent electrode layer (14).

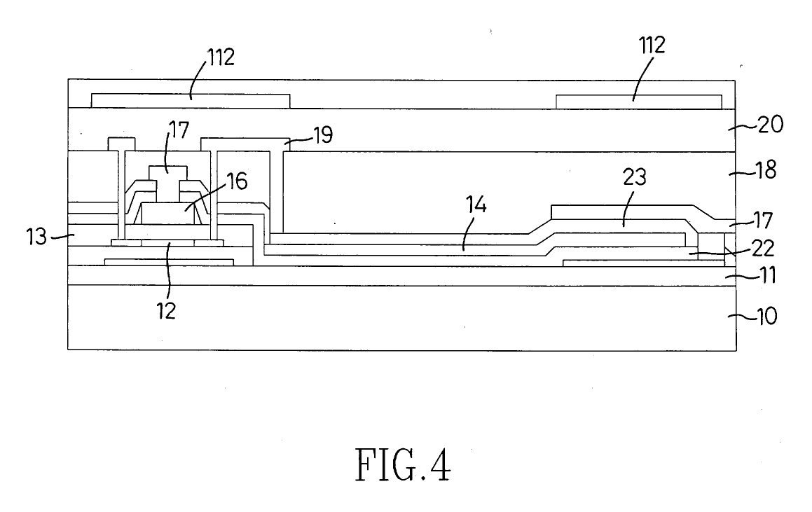

In FIG. 4, a thin film display panel is manufactured in accordance with the third embodiment of the invention, which is basically similar to that in the first embodiment, except that an oxide layer (22) is first formed over the buffer layer (11), such that an oxide buffer layer (11), an oxide layer (22), a transparent electrode layer (14), a high potential dielectric layer (23), a first metal layer (17), a third oxide layer (18), and a passivation layer (20) are respectively formed over the substrate (10).

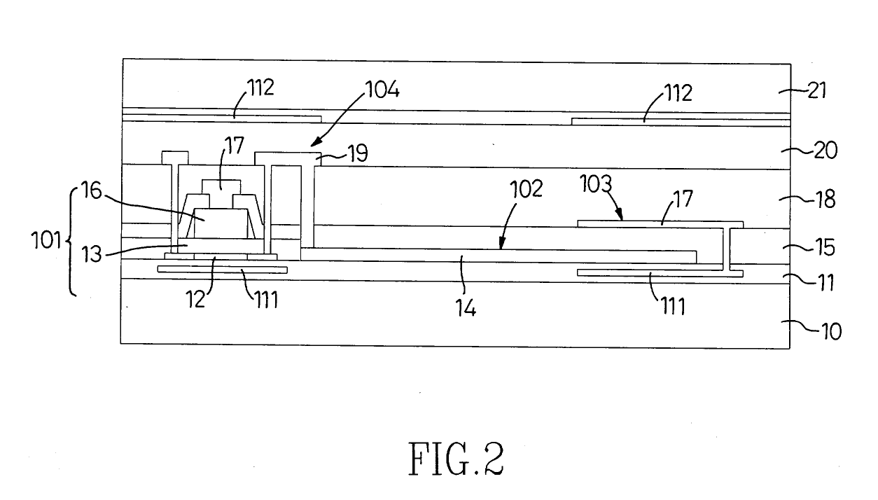

The thin film transistor for an LCD panel mentioned above is to be transferred onto a second substrate (21) by a back-end fabrication process to be described. In FIG. 2, the semiconductor component for the display panel is first formed on the first substrate (10), including a semiconductor active layer (12), gate insulating layer (13), and a gate electrode (16). A two-layer storage capacitor is formed by the transparent electrode layer (14), the second insulating layer (15), and the first metal layer (17) in that order on the first substrate. After the back-end fabrication process, the semiconductor component is transferred onto the second substrate (21), wherein the thin film transistor (101) is inversely disposed on the second substrate (21), and the position of the transparent electrode layer (14) and the first metal layer (17) are interchanged. The fully flat back side of the transparent electrode layer (14) acts as the electrode plate, thus the quality of display image can be improved considerably.

The process for fabricating the semiconductor component is to be described below in conjunction with FIG. 2:

providing a first substrate (10) made with silicon, glass or plastic material;

forming a buffer layer (11), a layer of transparent oxide, over the substrate (10), for creating a first shielding layer (111) therein;

forming a semiconductor active layer (12) over the buffer layer (11), wherein the surface of the semiconductor active layer (12) is doped with ions to define the source region, the drain electrode and the gate electrode (not shown in diagram);

forming a gate insulating layer (13) over the semiconductor active layer (12), and a gate electrode (16) over the gate insulating layer (13);

forming a transparent electrode layer (14) over the buffer layer (11) on the periphery of the thin film transistor region (101);

forming a second insulating layer (15) over the thin film transistor region (101) and the transparent electrode layer (14);

forming a first metal layer (17) over the gate electrode (16) and the second insulating layer (15), which corresponds to the position on one part of the transparent electrode layer (14), and the first metal layer (17) can be connected to the first shielding layer (111) by dry etching and metallizing process;

forming a third oxide layer (18) overlaying the gate insulating layer (13), the first metal layer (17), and the second insulating layer (15);

connecting the transparent electrode layer (14) to the semiconductor active layer (12) through the third oxide layer (18) by dry etching and metallizing process;

forming a second metal layer (19) over the third oxide layer (18), such that the first metal layer (17) and the second metal layer (19) are separated to prevent cross talks;

forming a passivation layer (20) over the second metal layer (19) and the third oxide layer (18);

forming a second shielding layer (112) over the passivation layer (20), corresponding to the positions on thin film transistor region (101), the first metal layer (17), and the second metal layer (19) to prevent light penetration;

bonding the second substrate (21) onto the passivation layer (20) made with silicon, glass, or polymer material, wherein the bonding can be in the form of direct bonding, anodic bonding, low temperature bonding, intermediate bonding, or adhesive bonding; and

removing the first substrate (10) by etching or polishing.

It becomes apparent that one part of the transparent electrode layer being connected to the thin film transistor and the storage capacitor acts as an electrode plate for the storage capacitor, and the transparent electrode layer is disposed to correspond to the first metal layer to form a two-layer storage capacitor. Since there are not cross talk effects between the transparent electrode layer and the first metal layer, the gap between the transparent electrode layer and the first metal layer can be kept small in order to enhance the capacitance for the storage capacitor. The transparent electrode layer is directly made to one part of the storage capacitor, with simple lithography and metallizing processes, thus simplifying the overall process.

The foregoing description of the preferred embodiments of the present invention is intended to be illustrative only and, under no circumstances, should the scope of the present invention be so restricted.

What is claimed is:

1. A storage capacitor for an active matrix LCD panel is formed over a substrate comprising a thin film transistor region, a transparent electrode layer, and a plurality of data lines and gate lines, wherein
the thin film transistor is inversely disposed on the substrate, such that a semiconductor active layer, a gate insulating layer, and gate electrode are respectively formed over the substrate;
the transparent electrode layer is disposed on the periphery of the thin film transistor region overlying a plurality of oxide layers;
the gate line is formed underneath the gate electrode and in between the oxide layers; and
the data line is also formed in between the oxide layers and connected to the transparent electrode layer and the thin film transistor region.

2. The LCD panel as claimed in claim 1, wherein a buffer layer is formed over the thin film transistor region and the transparent electrode layer, having a shielding layer created therein, wherein the shielding layer corresponds to the position on the transparent electrode layer, and the shielding layer is connected to the first metal layer underneath to form a three-layer storage capacitor together with the shielding layer, the transparent electrode layer and the first metal layer.

3. The LCD panel as claimed in claim 1, wherein a semiconductor active layer is formed underneath the buffer layer to correspond to the transparent electrode layer, and the semiconductor active layer is connected to the first metal layer to form a three-layer storage capacitor together with the semiconductor active layer, the transparent electrode layer and the first metal layer.

4. The LCD panel as claimed in claim 2, wherein a second shielding layer is formed over the substrate to correspond to the positions on the thin film transistor region, the first metal layer and the second metal layer.

5. The LCD panel as claimed in claim 3, wherein a second shielding layer is formed over the substrate to correspond to the positions on the thin film transistor region, the first metal layer and the second metal layer.

6. The LCD panel as claimed in claim 1, wherein the gate insulating layer extends downward to the lower portion of the transparent electrode layer to become one of the oxide layers in between the transparent electrode and the substrate.

7. The LCD panel as claimed in claim 2, wherein the gate insulating layer extends downward to the lower portion of the transparent electrode layer to become one of the oxide layers in between the transparent electrode and the substrate.

8. The LCD panel as claimed in claim 3, wherein the gate insulating layer extends downward to the lower portion of the transparent electrode layer to become one of the oxide layers in between the transparent electrode and the substrate.

9. The LCD panel as claimed in claim 4, wherein the gate insulating layer extends downward to the lower portion of the transparent electrode layer to become one of the oxide layers in between the transparent electrode and the substrate.

10. The LCD panel as claimed in claim 1, wherein any one of the plurality of oxide layers can be made of a high dielectric material.

11. The LCD panel as claimed in claim 1, wherein the gate line is made from metal or polysilicon material.

12. A method for fabricating storage capacitors on an LCD panel includes the steps of:
providing a first substrate;
forming a buffer layer over the substrate;
forming a thin film transistor region by a semiconductor active layer over the buffer layer and doping with ions on the surface to define the source electrode and the drain electrode, wherein the thin film transistor is formed by a semiconductor active layer, a gate insulating layer and a gate electrode;
forming a transparent electrode layer on the periphery of the thin film transistor region;
forming a second oxide layer over the thin film transistor region and the transparent electrode layer;
forming a first metal layer to correspond to the positions on the gate electrode and one part of the transparent electrode layer;
forming a third oxide layer over first metal layer;
forming a second metal layer over the third oxide layer, wherein the second metal layer is connected to the other part of the transparent electrode layer and the semiconductor active layer;
forming a passivation layer over the second metal layer and the third oxide layer; and
removing the first substrate after the back-end fabrication by etching back or polishing.

13. The method for fabricating storage capacitors on an LCD panel as claimed in claim 12, wherein a first shielding layer is formed in the buffer layer, to correspond to the positions on the first metal layer and the semiconductor active layer.

14. The method for fabricating storage capacitors on an LCD panel as claimed in claim 13, wherein a second shielding layer is formed over the passivation layer to correspond to the positions on the semiconductor active layer, the first metal layer and the second metal layer.

15. The method for fabricating storage capacitors on an LCD panel as claimed in claim 12, wherein the process steps after the formation of the second oxide layer is to further include the connecting of the first metal layer to the first shielding layer.

16. The method for fabricating storage capacitors on an LCD panel as claimed in claim 12, wherein the process steps for forming a semiconductor active layer is to further include the formation of a part of the semiconductor active layer to correspond to one part of the transparent electrode layer and the crossover position with the first metal layer.

17. The method for fabricating storage capacitors on an LCD panel as claimed in claim 16, wherein the process steps after the formation of the second oxide layer is to further include the connecting of the part of the semiconductor active layer to the first metal layer.

18. The method for fabricating storage capacitors on an LCD panel as claimed in claim 13, wherein the second oxide layer is made from high dielectric material.

19. The method for fabricating storage capacitors on an LCD panel as claimed in claim 15, wherein the second oxide layer is made from high dielectric material.

20. The method for fabricating storage capacitors on an LCD panel as claimed in claim 17, wherein the second oxide layer is made from high dielectric material.

21. The method for fabricating storage capacitors on an LCD panel as claimed in claim 12, wherein the process steps before the removal of the first substrate is to further include bonding of the second substrate onto the passivation layer.

22. The method for fabricating storage capacitors on an LCD panel as claimed in claim 15, wherein the step before the removal of the first substrate is to further include bonding of the second substrate onto the passivation layer.

23. The method for fabricating storage capacitors on an LCD panel as claimed in claim 17, wherein the step before the removal of the first substrate is to further include the bonding of the second substrate onto the passivation layer.

24. The method for fabricating storage capacitors on an LCD panel as claimed in claim 21, wherein the bonding can be in the form of direct bonding, anodic bonding, lower temperature bonding, intermediate bonding, or adhesive bonding.

25. The method for fabricating storage capacitors on an LCD panel as claimed in claim 22, wherein the bonding can be in the form of direct bonding, anodic bonding, lower temperature bonding, intermediate bonding, or adhesive bonding.

26. The method for fabricating storage capacitors on an LCD panel as claimed in claim 23, wherein the bonding can be in the form of direct bonding, anodic bonding, lower temperature bonding, intermediate bonding, or adhesive bonding.
